(19) United States
(12) Patent Application Publication
(10) Pub. No.: US 2026/0133399 A1
(43) Pub. Date: May 14, 2026

(54) STOPPING COMPONENT AND ELECTRONIC DEVICE

(71) Applicant: Luxvisions Innovation Technology Corp. Limited, Guangzhou City (CN)

(72) Inventors: Jianfeng ZHENG, Guangzhou City (CN); Zhuohong LI, Guangzhou City (CN); Jiadong ZHANG, Guangzhou City (CN)

(73) Assignee: Luxvisions Innovation Technology Corp. Limited, Guangzhou City (CN)

(21) Appl. No.: 19/318,025

(22) Filed: Sep. 3, 2025

(30) Foreign Application Priority Data
Nov. 14, 2024 (CN) 202422784064.7

(51) Int. Cl. G02B 7/09; H02K 7/00

(52) U.S. Cl. CPC G02B 7/09; H02K 7/003

(57) ABSTRACT

An electronic device includes a driving member provided with a driving shaft, two sides of the driving member are symmetrically provided with a first fixing member and a second fixing member, the first fixing member is connected with a first threaded rod, the second fixing member is connected with a second threaded rod, the first threaded rod is connected with a first end of the driving shaft through a first connecting member, the second threaded rod is connected with a second end of the driving shaft through a second connecting member, and the driving shaft rotates to drive the first connecting member and the second connecting member synchronously when rotating, the first connecting member drives the first threaded rod to rotate and move relative to the first fixing member, and the second connecting member drives the second threaded rod to rotate and move relative to the second fixing member.

### CLAIM OF PRIORITY AND CROSS-REFERENCE TO RELATED APPLICATION(S)

This application claims the benefit of Chinese Patent Application No. 202422784064.7, filed on Nov. 14, 2024, which is incorporated herein by reference in its entirety.

### BACKGROUND OF THE DISCLOSURE

### 1. Field of the Disclosure

The present disclosure relates to the field of mechanical equipment, and particularly to a stopping component and an electronic device.

### 2. Description of the Related Art

In modern optical systems, autofocus and optical stabilization functions are crucial for improving imaging quality and user experience. The implementation of these functions relies on precise mechanical transmission and control systems, among which the stopping component is one of the key members, and its performance directly affects the positioning accuracy and motion stability of the optical component. Common stopping components usually use motors with a single output shaft, and use a fixing screw to make a nut move back and forth in a straight line along the screw. However, this design performs poorly in terms of balance and stability, and the motor is fixed to the mounting plate with screws, resulting in low overall structural stability and inability to effectively ensure transmission accuracy and reliability during focusing.

### BRIEF DESCRIPTION OF THE DISCLOSURE

In view of this, the purpose of the present disclosure is to provide a stopping component and an electronic device that may effectively improve the balance and stability of transmission, and enhance transmission accuracy.

In the first aspect, the present embodiment of the disclosure provides a stopping component, which comprises: a driving member, including a driving shaft; a first fixing member and a second fixing member, symmetrically located on two sides of the driving member, the first fixing member having a first threaded hole inside, and the second fixing member having a second threaded hole inside; a first threaded rod and a second threaded rod, the first threaded rod being connected with the first fixing member through the first threaded hole, and the second threaded rod being connected with the second fixing member through the second threaded hole; a first connecting member connecting a first end of the driving shaft with the first threaded rod; and a second connecting member connecting a second end of the driving shaft with the second threaded rod; wherein the driving shaft drives the first connecting member and the second connecting member to rotate synchronously when rotating, the first connecting member drives the first threaded rod to rotate and move relative to the first fixing member, and the second connecting member drives the second threaded rod to rotate and move relative to the second fixing member.

Furthermore, one end of the first threaded rod is provided with a first slot, and one end of the first connecting member is movably arranged in the first slot; one end of the second threaded rod is provided with a second slot, and one end of the second connecting member is movably arranged in the second slot.

Furthermore, the first slot and the second slot are respectively configured as a laterally through U-shaped slot, the first connecting member extends into the first threaded rod from a top opening of the first slot, and the second connecting member extends into the second threaded rod from a top opening of the second slot.

Furthermore, the first connecting member comprises a first inserting portion and a first fixing portion, the first inserting portion is arranged as a rectangle with a cross-section adapted to the U-shaped groove and is connected with the first slot, the first fixing portion is provided with a first connecting groove, the first end of the driving shaft extends into the first connecting groove and is welded with the first fixing portion; the second connector comprises a second inserting portion and a second fixing portion, the second inserting portion is arranged as a rectangle with a cross-section adapted to the U-shaped groove and is connected to the second slot, the second fixing portion is provided with a second connecting groove, and the second end of the driving shaft extends into the second connecting groove and is welded to the second fixing portion.

Furthermore, the first fixing portion is provided with a first through hole that intersects perpendicularly with the first connecting groove; the second fixing portion is provided with a second through hole that intersects perpendicularly with the second connecting groove.

Furthermore, the first threaded rod and/or the second threaded rod are provided with a sensor member, and the sensor member is configured to detect the positions of the first threaded rod and the second threaded rod.

Furthermore, one end of the first threaded rod and/or the second threaded rod far from the driving shaft is provided with an installing groove, and the sensor member is embedded in the installing groove.

Furthermore, a thread direction of the first threaded rod is opposite to a thread direction of the second threaded rod.

Furthermore, the stopping component further comprises a third fixing member, and the driving member is fixed on the third fixing member.

In the second aspect, the embodiment of the disclosure also provides an electronic device, which comprises a fixing bracket, an optical component and a stopping component as described in the first aspect, the stopping component comprises a first fixing member, a second fixing member and a third fixing member, the first fixing member, the second fixing member and the third fixing member are respectively connected with the fixing bracket, and the optical component is connected with the first threaded rod and/or the second threaded rod.

The present embodiment of the disclosure provides a stopping component and an electronic device, the electronic device comprising a driving member provided with a driving shaft, symmetrically arranged on two sides of the driving member with a first fixing member and a second fixing member, wherein the first fixing member is connected to a first threaded rod in a spiral manner, and the second fixing member is connected to a second threaded rod in a spiral manner. The first threaded rod is connected to a first end of the driving shaft through the first connecting member, and the second threaded rod is connected to a second end of the driving shaft through the second connecting member. When the driving shaft rotates, the first connecting member drives the first threaded rod to rotate and move relative to the first fixing member, and the second connecting member drives the second threaded rod to rotate and move relative to the second fixing member. In the stopping component, the movement of the first threaded rod and the second threaded rod may drive the adjustment of the position of the optical components connected with them, thus realizing the efficient auto focusing and optical anti shake functions.

### BRIEF DESCRIPTION OF THE DRAWINGS

The above and other objectives, features, and advantages of the present disclosure will become clearer through the following description of the embodiments of the present disclosure with reference to the accompanying drawings:

FIG. 1 is a schematic diagram of an overall structure in the embodiment of the disclosure;

FIG. 2 is a schematic diagram of a connection between a second threaded rod and a second fixing member in the embodiment of the disclosure;

FIG. 3 is a schematic diagram of a connection between a first threaded rod and a first fixing member in the embodiment of the disclosure;

FIG. 4 is a schematic diagram of the explosive structure in the embodiment of the disclosure.

### DETAILED DESCRIPTION OF EMBODIMENTS OF THE DISCLOSURE

The following describes the present application based on embodiments, but the present application is not limited to these embodiments. In the following detailed description of the present application, specific details are described in detail. For those skilled in the art, the present application may be fully understood without the description of these detailed parts. To avoid confusion of the essence of the present application, the well-known methods, processes, procedures, members, and circuits have not been described in detail.

In addition, ordinary technical personnel in this field should understand that the accompanying drawings provided here are for illustrative purposes and may not necessarily be drawn to scale.

Unless otherwise specified and limited, the terms “installation”, “connection”, “coupling”, “fixation”, etc. should be broadly understood, for example, it may be fixed connected, detachable connected, or integrated; it may be mechanical connected or electrical connected; it may be directly connected or indirectly connected through an intermediate medium, and may be a connection within two members or an interaction relationship between two members, unless otherwise specified. For ordinary technical personnel in this field, the specific meanings of the above terms in this application may be understood according to the specific situation.

Unless explicitly required by the context, words such as “including” and “containing” in the entire application document should be interpreted as containing rather than exclusive or exhaustive; that is to say, it means “including but not limited to”.

In the description of this application, it should be understood that the terms “first”, “second”, etc. are only used for descriptive purposes and cannot be understood as indicating or implying relative importance. In addition, in the description of this application, unless otherwise specified, the meaning of “multiple” refers to two or more.

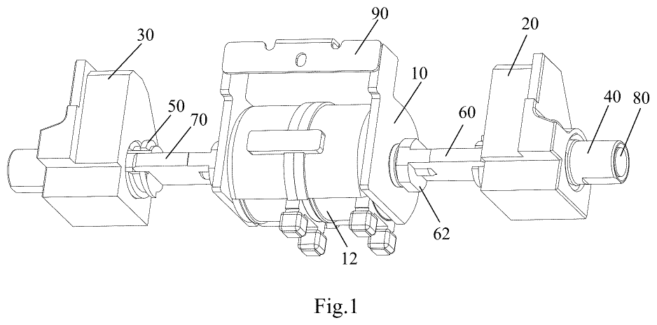

FIG. 1 is a schematic diagram of an overall structure of a stopping component of the present application. Referring to FIG. 1, the stopping component includes a driving member 10, a first fixing member 20, and a second fixing member 30, which are symmetrically arranged on two sides of the driving member 10. The first fixing member 20 is provided with a first threaded hole 21, and the first threaded rod 40 is connected to the first fixing member 20 through the first threaded hole 21 in a spiral manner. The second fixing member 30 is provided with a second threaded hole 31, and the second threaded rod 50 is connected with the second fixing member 30 through the second threaded hole 31. The driving member 10 includes a driving shaft 11, and two ends of the driving shaft 11 are respectively connected to a first connecting member 60 and a second connecting member 70. The first threaded rod 40 is connected with a first end of the driving shaft 11 through the first connecting member 60, and the second threaded rod 50 is connected with a second end of the driving shaft 11 through the second connecting member 70. When the driving shaft 11 rotates, it may drive the first threaded rod 40 and the second threaded rod 50 to rotate through the first connecting member 60 and the second connecting member 70. When the first threaded rod 40 rotates, it may move relative to the first fixing member 20. When the second threaded rod 50 rotates, it may move relative to the second fixing member 30. By adjusting the positions of the first threaded rod 40 and the second threaded rod 50, the stopping component may accurately control the position of structures such as optical components connected with the driving member 10, and realize functions such as automatic focusing and optical anti shake.

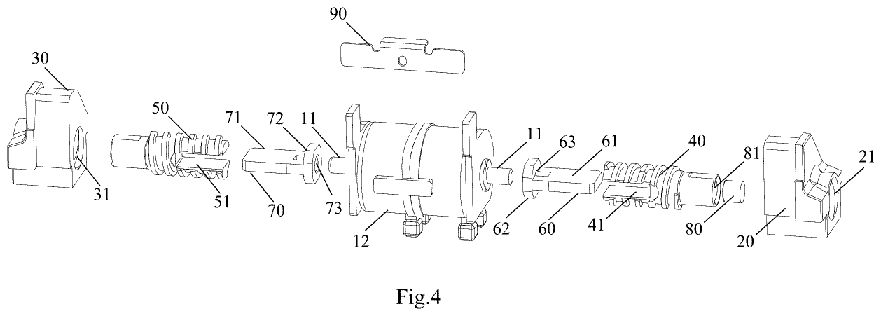

FIG. 1 is a schematic diagram of an overall structure in the embodiment, and FIG. 4 is a schematic diagram of an explosive structure of the stopping component in this embodiment. Referring to FIGS. 1 and 4, the driving member 10 comprises a driving shaft 11 and a body 12. Two ends of the driving shaft 11 extend out to outside of the body 12, and are opposite to the first fixing member 20 and the second fixing member 30, and the driving shaft 11 rotates relative to the body 12. The first fixing member 20 and the second fixing member 30 are symmetrically arranged on two sides of the driving member 10. The first threaded hole 21 and the second threaded hole 31 are coaxially arranged with the driving shaft 11, facilitating the driving shaft 11 to drive the first threaded rod 40 and the second threaded rod 50 to rotate.

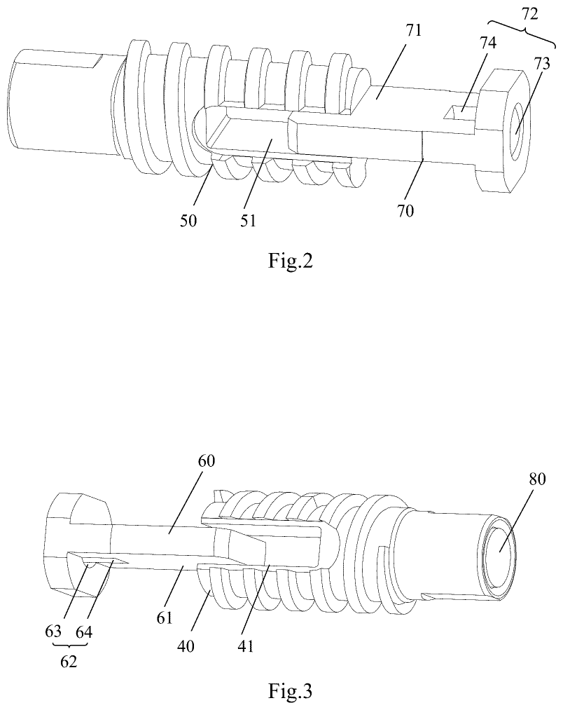

Referring to FIG. 1, the driving shaft 11 is connected to the first threaded rod 40 through the first connecting member 60 for driving, and to the second threaded rod 50 through the second connecting member 70 for driving. FIG. 2 is a schematic diagram of a connection between the second connecting member 70 and the second threaded rod 50 in this embodiment, and FIG. 3 is a schematic diagram of a connection between the first connecting member 60 and the first threaded rod 40 in this embodiment. Referring to FIG. 3, the first connector 60 includes a first inserting portion 61 and a first fixing portion 62. Referring to FIG. 4, the first inserting portion 61 is connected to the first threaded rod 40, and the first fixing portion 62 is fixedly connected to the driving shaft 11. Referring to FIG. 2, the second connecting member 70 includes a second inserting portion 71 and a second fixing portion 72. Referring to FIG. 4, the second inserting portion 71 is connected with the second threaded rod 50, and the second fixing portion 72 is fixedly connected with the driving shaft 11. Two ends of the driving shaft 11 are symmetrically connected to the first threaded rod 40 and the second threaded rod 50 to evenly distribute the load, reduce the unbalanced force caused by unilateral load, and improve the balance and stability of the overall structure.

Referring to FIG. 3, the first fixing portion 62 is provided with a first connecting groove 63, the first connecting groove 63 is located at an end of the first connecting member 60, and an opening faces the driving shaft 11. Referring to FIG. 2, the second fixing portion 72 is provided with a second connecting groove 73, the second connecting groove 73 is located at an end of the second connecting member 70, and an opening faces the driving shaft 11. Referring to FIG. 4, the first end of the driving shaft 11 extends into the first connecting groove 63 and is welded to the first fixing portion 62, and the second end of the driving shaft 11 extends into the second connecting groove 73 and is welded to the second fixing portion 72. The welding connection may guarantee the connection strength between the driving shaft 11 and the first connecting member 60 and the second connecting member 70, and improve the durability and stability of the structure. Optionally, the driving shaft 11 may also be fixedly connected with the first connecting member 60 and the second connecting member 70 by means of bonding or cold press fitting.

Furthermore, referring to FIG. 3, the first fixing portion 62 is provided with a first through hole 64 that intersects perpendicularly with the first connecting groove 63. Referring to FIG. 2, the second fixing portion 72 is provided with a second through hole 74 that intersects perpendicularly with the second connecting groove 73. Referring to FIG. 4, the first through hole 64 is located at an end of the first connecting groove 63 away from the driving shaft 11, and the second through hole 74 is located at an end of the second connecting groove 73 away from the driving shaft 11, avoiding intersection with a notch of the first connecting groove 63 and a notch of the second connecting groove 73. The setting of the first through hole 64 and the second through hole 74 may effectively increase the welding points between the driving shaft 11 and the first connecting member 60 and the second connecting member 70, improve the connection strength, and ensure that the driving shaft 11 will not fall off from the first connecting groove 63 and the second connecting member 70 when rotating at a high speed. Understandably, first connecting member 60 and second connecting member 70 are kept at a certain distance from the body 12 to avoid friction between first connecting member 60 and second connecting member 70 and the body 12, which may affect rotation.

Referring to FIG. 4, the first inserting portion 61 is movably connected with the first threaded rod 40, and the second inserting portion 71 is movably connected with the second threaded rod 50. Referring to FIGS. 2 and 3, one end of the first threaded rod 40 is provided with a first slot 41, one end of the first connecting member 60 is movably arranged in the first slot 41, one end of the second threaded rod 50 is provided with a second slot 51, and one end of the second connecting member 70 is movably arranged in the second slot 51. When the driving shaft 11 rotates, the torque may be transmitted to the first threaded rod 40 and the second threaded rod 50 through the first connecting member 60 and the second connecting member 70, so that the first threaded rod 40 and the second threaded rod 50 start to rotate. The first fixing member 20, the second fixing member 30, and the body 12 are relatively fixed. The movable connection between the first connecting member 60 and the first threaded rod 40, as well as the movable connection between the second connecting member 70 and the second threaded rod 50, allow the first threaded rod 40 and the second threaded rod 50 to rotate without being constrained, thereby achieving relative movement between the first fixing member 20 and the second fixing member 30.

Referring to FIGS. 2 and 3, the first slot 41 and the second slot 51 are respectively configured as a laterally through U-shaped slot, the first connecting member 60 extends into the first threaded rod 40 from a top opening of the first slot 41, and the second connecting member 70 extends into the second threaded rod 50 from a top opening of the second slot 51. The first inserting portion 61 and the second inserting portion 71 are both arranged as rectangles whose cross-sections are adapted to the U-shaped slots. The U-shaped groove has a flat structure, which may increase the contact area between the rectangular first inserting portion 61 and the rectangular second inserting portion 61, provide better torque transmission capability, and reduce the risk of sliding. Moreover, the fitting structure of this shape has high torsional resistance, which may ensure that there will be no distortion, fracture or other damage during the driving process, ensuring the stability and reliability of the overall structure and extending the service life of the stopping component.

Referring to FIGS. 2 and 3, the connection between the first inserting portion 61 and the first fixing portion 62 is arranged in a rectangular shape. The overall structure of the first connecting member 60 is rectangular, and one end close to the driving shaft 11 is provided with a ring structure to facilitate the sleeve connection between the first connecting member 60 and the driving shaft 11. The first through hole 64 is arranged on a cuboid structure, which is convenient for processing, and makes the depth of the first through hole 64 smaller, which is convenient for welding the driving shaft 11 and the first connecting member 60, and improves the stability of the connection. The structure of the second connecting member 70 is the same as that of the first connecting member 60, so it will not be repeated here.

Referring to FIGS. 2 and 3, the thread direction of the first threaded rod 40 is opposite to that of the second threaded rod 50, and the thread direction of the threaded hole of the first fixing member 20 is opposite to that of the threaded hole of the second fixing member 30. When the first threaded rod 40 and the second threaded rod 50 are driven to rotate in the same direction through the driving shaft 11, they may move synchronously and in the same direction with respect to the first fixing member 20 and the second fixing member 30, ensuring the stability of movement.

Further, referring to FIG. 4, the stopping component is also provided with a sensor member 80, and the sensor member 80 is arranged on the first threaded rod 40 and/or the second threaded rod 50. The sensor member 80 may detect the positions of the first threaded rod 40 and the second threaded rod 50, so as to accurately master and control the positions and moving distances of the first threaded rod 40 and the second threaded rod 50. The end of the first threaded rod 40 and/or the second threaded rod 50 away from the driving shaft 11 is provided with a installing groove 81, and the sensor member 80 is embedded in the installing groove 81 to avoid collision with other structures. The position information provided by sensor member 80 allows the control system to accurately control the movement of the first threaded rod 40 and the second threaded rod 50, ensuring that they move according to the predetermined position and speed, thereby achieving precise autofocus and optical stabilization functions.

Optionally, the sensor member 80 may adopt various types of sensors, such as photoelectric sensors, magnetic sensors, or Hall effect sensors, to meet different application requirements. In addition, the sensor member 80 may be flexibly installed at different positions of the first threaded rod 40 and/or the second threaded rod 50 according to the specific application requirements to achieve the best detection effect.

Referring to FIGS. 1 and 4, the stopping component further includes a third fixing member 90, and the driving member 10 is fixed on the third fixing member 90. The driving member 10 may be welded with other structures through the third fixing member 90, which may reduce the vibration caused by the driving shaft 11 when rotating at high speed or under high load, and improve the stability and stability of the movement of the first threaded rod 40 and the second threaded rod 50.

The stopping component of this embodiment is symmetrically provided with a first threaded rod and a second threaded rod on two sides of the driving portion, and is connected and driven by the first connecting member and the second connecting member. This symmetrical design ensures that the load is evenly distributed on two sides, significantly improving the balance and stability of the entire system, reducing vibration and imbalance problems caused by one-sided loads, and ensuring stability and reliability in high-precision applications.

This embodiment also provides an electronic device, which includes a fixing bracket, an optical component, and the stopping component in the above embodiment. The stopping component comprises a first fixing member 20, a second fixing member 30 and a third fixing member 90. The first fixing member 20, the second fixing member 30 and the third fixing member 90 are respectively connected with the fixing bracket to ensure the stability and reliability of the overall structure. The optical component is connected with the first threaded rod 40 and/or the second threaded rod 50, so that the position of the optical component may be flexibly adjusted according to specific needs. The stopping component is also provided with a sensor member 80 to detect the positions of the first threaded rod 40 and/or the second threaded rod 50, effectively ensuring the accuracy and stability of the movement of the optical assembly, and achieving precise positioning or focusing and other functions.

When the driving member rotates, the stopping component used in the electronic device of the embodiment transmits the driving force to the first threaded rod and the second threaded rod through the first connecting member and the second connecting member, respectively, so that the first threaded rod moves relative to the first fixing member and the second threaded rod moves relative to the second fixing member, realizing synchronous movement and ensuring the stability of the overall system. In addition, the stopping component is also equipped with a sensor member to detect the positions of the first threaded rod and/or the second threaded rod, effectively ensuring the accuracy and stability of the optical component movement, and achieving precise positioning or focusing functions.

The above description is only a preferred embodiment of the present application and is not intended to limit the present application. For those skilled in the art, the present application may have various modifications and variations. Any modifications, equivalent substitutions, improvements, etc. made within the spirit and principles of this application may be included within the scope of protection of this application.

I/We claim:

1. A stopping component, comprising:
a driving member (10), including a driving shaft (11);
a first fixing member (20) and a second fixing member (30), symmetrically located on two sides of the driving member (10), the first fixing member (20) having a first threaded hole (21) inside, and the second fixing member (30) having a second threaded hole (31) inside;
a first threaded rod (40) and a second threaded rod (50), the first threaded rod (40) being connected with the first fixing member (20) through the first threaded hole (21), and the second threaded rod (50) being connected with the second fixing member (30) through the second threaded hole (31);
a first connecting member (60) connecting a first end of the driving shaft (11) with the first threaded rod (40); and
a second connecting member (70) connecting a second end of the driving shaft (11) with the second threaded rod (50);
wherein the driving shaft (11) drives the first connecting member (60) and the second connecting member (70) to rotate synchronously when rotating, the first connecting member (60) drives the first threaded rod (40) to rotate and move relative to the first fixing member (20), and the second connecting member (70) drives the second threaded rod (50) to rotate and move relative to the second fixing member (30).

2. The stopping component according to claim 1, wherein one end of the first threaded rod (40) is provided with a first slot (41), and one end of the first connecting member (60) is movably arranged in the first slot (41);
one end of the second threaded rod (50) is provided with a second slot (51), and one end of the second connecting member (70) is movably arranged in the second slot (51).

3. The stopping component according to claim 2, wherein the first slot (41) and the second slot (51) are respectively configured as a laterally through U-shaped slot, the first connecting member (60) extends into the first threaded rod (40) from a top opening of the first slot (41), and the second connecting member (70) extends into the second threaded rod (50) from a top opening of the second slot (51).

4. The stopping component according to claim 3, wherein the first connecting member (60) comprises a first inserting portion (61) and a first fixing portion (62), the first inserting portion (61) is arranged as a rectangle with a cross-section adapted to the U-shaped groove and is connected with the first slot (41), the first fixing portion (62) is provided with a first connecting groove (63), the first end of the driving shaft (11) extends into the first connecting groove (63) and is welded with the first fixing portion (62);
the second connector (70) comprises a second inserting portion (71) and a second fixing portion (72), the second inserting portion (71) is arranged as a rectangle with a cross-section adapted to the U-shaped groove and is connected to the second slot (51), the second fixing portion (72) is provided with a second connecting groove (73), and the second end of the driving shaft (11) extends into the second connecting groove (73) and is welded to the second fixing portion (72).

5. The stopping component according to claim 4, wherein the first fixing portion (62) is provided with a first through hole (64) that intersects perpendicularly with the first connecting groove (63);
the second fixing portion (72) is provided with a second through hole (74) that intersects perpendicularly with the second connecting groove (73).

6. The stopping component according to claim 1, wherein the first threaded rod (40) and/or the second threaded rod (50) are provided with a sensor member (80), and the sensor member (80) is configured to detect the positions of the first threaded rod (40) and the second threaded rod (50).

7. The stopping component according to claim 6, wherein one end of the first threaded rod (40) and/or the second threaded rod (50) far from the driving shaft (11) is provided with an installing groove (81), and the sensor member (80) is embedded in the installing groove (81).

8. The stopping component according to claim 1, wherein a thread direction of the first threaded rod (40) is opposite to a thread direction of the second threaded rod (50).

9. The stopping component according to claim 1, wherein the stopping component further comprises a third fixing member (90), and the driving member (10) is fixed on the third fixing member (90).

10. An electronic device, wherein the electronic device comprises a fixing bracket, an optical component and a stopping component according to claim 1, the stopping component comprises a first fixing member (20), a second fixing member (30) and a third fixing member (90), the first fixing member (20), the second fixing member (30) and the third fixing member (90) are respectively connected with the fixing bracket, and the optical component is connected with the first threaded rod (40) and/or the second threaded rod (50).
